(19) United States
(12) Patent Application Publication
(10) Pub. No.: US 2006/0069818 A1
(43) Pub. Date: Mar. 30, 2006

(54) Synchronizing direct memory access and evacuation operations in a computer system

(76) Inventors: Cliff Mather, San Jose, CA (US); Kazunobu Nishime, Milpitas, CA (US); Donald J. Cleland, Aptos, CA (US); Harish S. Babu, Santa Clara, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/950,719

(22) Filed: Sep. 27, 2004

(51) Int. Cl. G06F 13/28

(52) U.S. Cl. 710/22

(57) ABSTRACT

A computer-implemented method for performing an evacuation request pertaining to a set of memory pages. The method includes inhibiting new DMA operations on a range of memory, the range of memory overlaps with at least a first portion of the set of memory pages associated with the evacuation request. The method further includes deferring evacuating the set of memory pages pursuant to the evacuation request until all existing DMA requests that pertain to at least a second portion of the set memory pages are drained. The method additionally includes performing the evacuating after the draining is completed for the all existing DMA requests. The method also includes enabling the new DMA operations after the performing the evacuating is completed.

### BACKGROUND OF THE INVENTION

A computer system may sometimes have a need to evacuate the content of a block of memory. For example, when it is suspected that a block of memory may be defective, it is desirable to remove that block of memory from use. As another example, in a computer with multiple partitions, it may be useful to assign a block of memory from one partition to another partition (for load balancing, for example). Since the block of memory to be removed or reassigned may be accessed by executing processes and/or devices, it is necessary to properly evacuate the content of the memory block so that such executing processes and/or devices can continue with minimal disruption vis-à-vis a new memory block. Proper evacuation is also important to avoid conflicts between the evacuation operation and any pending or new direct memory access (DMA) operation involving the memory block since one of the most challenging use scenarios involves evacuating a memory block that is currently in use for DMA accesses by I/O devices.

To facilitate discussion, FIG. 1 shows a typical prior art computer system, including a CPU 102, memory 104, and a plurality of I/O devices of which I/O devices 106 and 108 are representative. CPU 102 is shown executing code implementing a plurality of I/O drivers 110 and 112, as well as code implementing I/O services 114. A direct memory access request (DMA) may be made by an I/O driver (such as 110) on behalf of an I/O device. The DMA mapping request is received by I/O services 114, which creates an outstanding I/O DMA request.

The outstanding I/O DMA request is then queued in queue 130 to be serviced when DMA resources become available. When DMA resources become available, the DMA request made by I/O driver 110 is serviced, resulting in an access to memory block 124.

FIG. 2 is a prior art logic diagram illustrating example problems that may be encountered when a memory block being evacuated is also accessed by I/O drivers for DMA. In FIG. 2, CPU 202 invokes the copy_page( ) operation (reference number 204) in order to atomically copy one memory page of memory block 206 to another memory page. Suppose the goal of the invoked copy_page( ) operation is to move the content of memory page 242 to another free memory page.

Thus, the copy_page( ) operation first determines whether there exists another memory page into which the content of memory page 242 may be evacuated. In the present example, memory page 252 is selected to be the memory page into which the content of memory page 242 is copied.

Suppose the copy_page( ) operation next begins to copy data from the source memory page (e.g., memory page 242) to the destination memory page (e.g., memory page 252). Shortly thereafter, I/O device 210 happens to want to write to memory page 242 using DMA. If the write operation is performed after some of the content of memory page 242 is in the process of being moved to the target memory page 252, it is possible that the content transferred to target memory page 252 does not contain the most up-to-date data written to memory page 242 during DMA accesses on behalf of I/O device 210. This may happen if, for example, the DMA write operation occurs to a part of memory page 242 that has recently been copied to target memory page 252.

Because of the potential for data corruption and other issues, there has been a reluctance to permit memory evacuation, particularly kernel memory evacuation, while DMA is enabled. One way of synchronizing memory evacuation and DMA involves suspending all DMA activities until evacuation is completed. However, this approach is disruptive and is not desirable from a performance standpoint.

### SUMMARY OF INVENTION

The invention relates, in an embodiment, to a computer-implemented method for performing an evacuation request pertaining to a set of memory pages. The method includes inhibiting new DMA operations on a range of memory, the range of memory overlaps with at least a first portion of the set of memory pages associated with the evacuation request. The method further includes deferring evacuating the set of memory pages pursuant to the evacuation request until all existing DMA requests that pertain to at least a second portion of the set memory pages are drained. The method additionally includes performing the evacuating after the draining is completed for the all existing DMA requests. The method also includes enabling the new DMA operations after the performing the evacuating is completed.

In another embodiment, the invention relates to a computer-implemented method in a computer system for synchronizing memory evacuation requests and direct memory access (DMA) requests with respect to a block of physical memory. The method includes receiving an evacuation request for evacuating a set of memory pages, the set of memory pages including at least a page of memory in the block of physical memory. The method also includes inhibiting new DMA operations on a range of physical memory, the range of physical memory overlaps with at least a portion of the set of memory pages associated with the evacuation request. The method additionally includes draining existing DMA requests that pertain to the set memory pages. The method also includes performing the evacuating after the draining is completed, and enabling the new DMA operations after the performing the evacuating is completed.

In yet another embodiment, the invention relates to an article of manufacture comprising a program storage medium having computer readable code embodied therein. The computer readable code is configured to perform an evacuation request pertaining to a set of memory pages. The article of manufacture includes computer readable code for inhibiting new DMA operations on a range of memory, the range of memory overlaps with at least a first portion of the set of memory pages associated with the evacuation request. The article of manufacture also includes computer readable code for deferring evacuating the set of memory pages pursuant to the evacuation request until all existing DMA requests that pertain to at least a second portion of the set memory pages are drained. The article of manufacture further includes computer readable code for performing the evacuating after the draining is completed for the all existing DMA requests. The article of manufacture additionally includes computer readable code for enabling the new DMA operations after the performing the evacuating is completed.

These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows a typical prior art computer system to facilitate discussion of evacuation and DMA operations.

FIG. 2 is a prior art logic diagram illustrating example problems that may be encountered when a memory block being evacuated is also accessed by I/O drivers for DMA.

FIG. 3 illustrates, in accordance with an embodiment of the present invention, the steps for synchronizing evacuation requests with DMA requests for a block of physical memory.

FIGS. 4A and 4B show, in accordance with an embodiment of the present invention, an implementation of the DMA/evacuation synchronization.

FIG. 5 illustrates, in accordance with an embodiment of the present invention, the steps for draining existing DMA requests that involve a range of memory associated with an evacuation request.

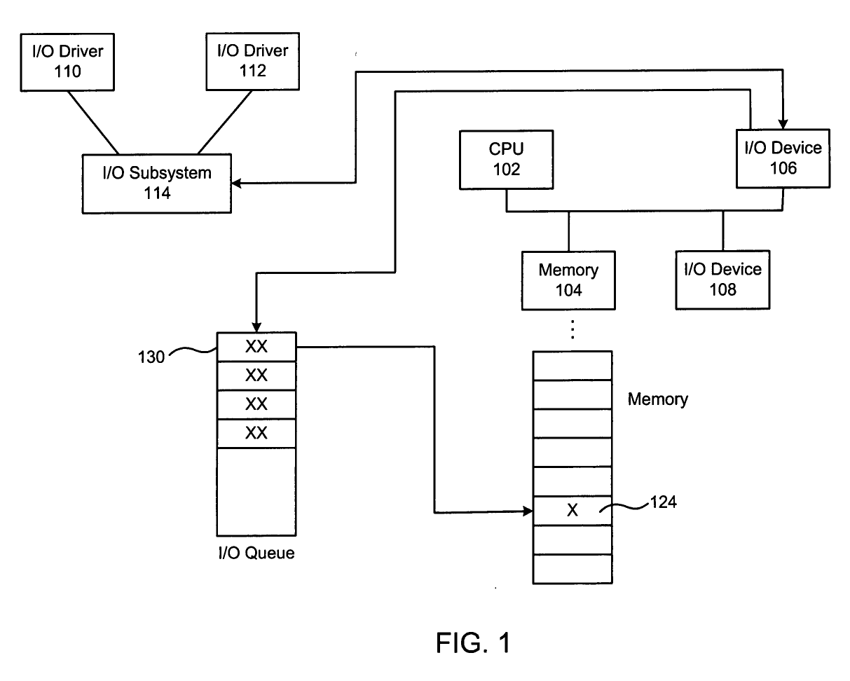

### DETAILED DESCRIPTION OF EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described hereinbelow, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

The invention relates, in an embodiment, to techniques and arrangements for synchronizing evacuation requests and DMA operations pertaining to a block of physical memory. In an embodiment, synchronization is performed in a manner that is substantially transparent (i.e., does not substantially impact) DMA operations and/or evacuation requests involving other blocks of memory in the system. Furthermore, embodiments of the invention enable such synchronization without requiring substantial changes to existing I/O architecture and/or kernel modifications and/or driver modifications.

In an embodiment, an evacuation request pertaining to a block of memory causes the kernel (e.g., the I/O subsystem) to inhibit new DMA operations on a range of memory that at least includes the block of memory associated with the evacuation request. For example, an evacuation request pertaining to a particular page of memory will inhibit new DMA operations at least to that page of memory.

Furthermore, existing DMA operations that involve the block of memory associated with the evacuation request are drained, i.e., all are allowed to complete. After all DMA operations that involve the block of memory associated with the evacuation request are drained, the block of memory is evacuated pursuant to the evacuation request.

If new DMA requests pertaining to the block of memory associated with the evacuation request are received before evacuation is completed, these DMA requests are queued up in the I/O request queue, waiting to be serviced. Once the evacuation is complete, the queued DMA requests are allowed to execute with respect to the block of memory that is formerly the subject of the evacuation request.

Since only DMA requests targeting the same block of memory as that associated with the evacuation request are inhibited, other DMA requests may proceed normally and are thus substantially unaffected. Further, while existing DMA requests pertaining to the same block of memory as that associated with the evacuation request are drained, other DMA requests are also allowed to proceed substantially unaffected. Thus the number of DMA requests that are potentially affected is limited, thereby limiting impact on system performance.

In accordance with embodiments of the invention, the mechanism for synchronization employs existing virtual memory, I/O, and driver arrangements with only minor modifications. In an embodiment, the modifications involve including in the definition of DMA resources the availability status of a range of memory block and having the virtual memory subsystem inform the I/O subsystem of the identity of the physical memory blocks that are currently affected by an evacuation request.

In an embodiment, after the virtual memory subsystem receives an evacuation request that maps to a particular physical memory block, the virtual memory subsystem may pass this information, which at least includes the identity or address of the affected physical memory block, to the I/O subsystem. If a new DMA request inquires the I/O subsystem whether DMA resources are available, that I/O subsystem would respond negatively if the new DMA request involves a memory block that has been noted by the virtual memory subsystem (and communicated to the I/O subsystem) as being concurrently involved with an evacuation request. Accordingly, the new DMA request is deferred, or queued, waiting for DMA resources to become available.

Once the evacuation request pertaining to that memory block is completed, the virtual memory subsystem may again inform the I/O subsystem of the completion of the drain operation(s). The I/O subsystem may then deem the DMA resources requested by the now-deferred DMA requests as “available.” The availability of the required DMA resources (as notified by the I/O subsystem) enables the deferred DMA requests to be performed.

In this manner, embodiments of the invention synchronize evacuation requests for a block of memory with DMA operations. Since DMA operations are inhibited only with respect to a limited range of physical memory and only until the evacuation operation is completed, the impact on system performance is limited. Furthermore, since the mechanism involved with synchronization in accordance with embodiments of the present invention employs existing I/O, virtual memory, and driver architectures of the operating system with only minor modifications, migration to the features offered by embodiments of the invention is simplified.

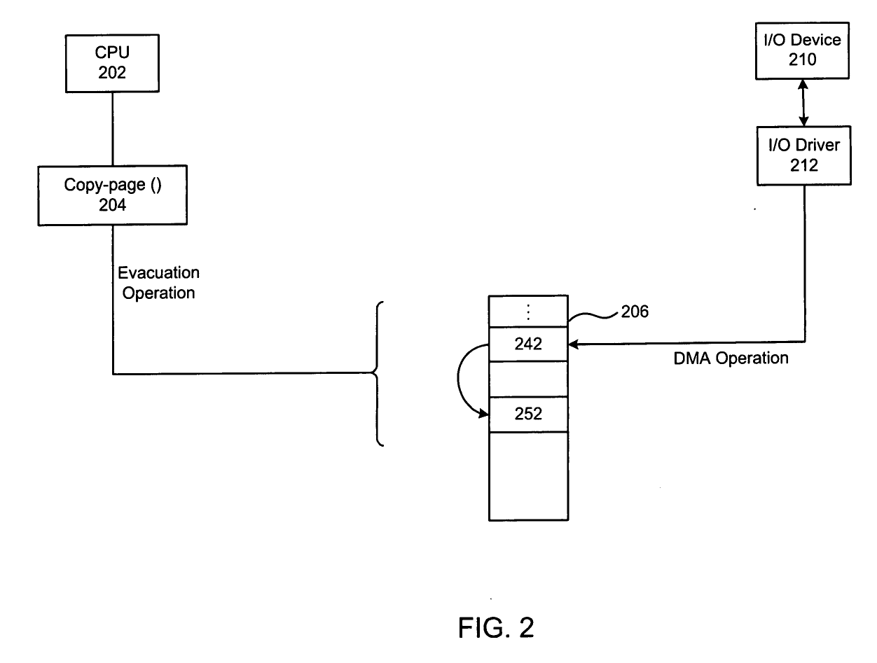

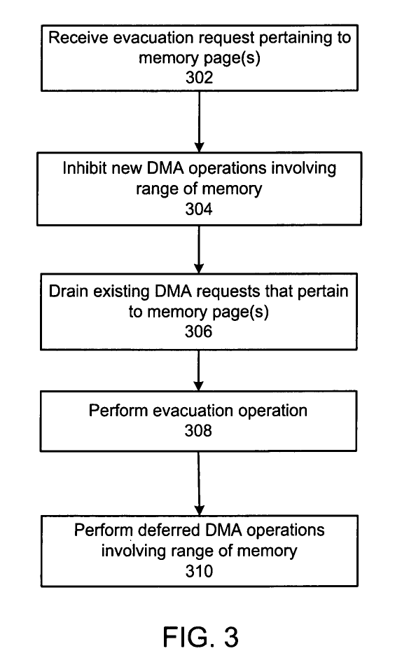

The features and advantages of the present invention may be better understood with reference to the figures and discussions that follow. FIG. 3 illustrates, in accordance with an embodiment of the present invention, the steps for synchronizing evacuation requests with DMA requests for a block of physical memory. In block 302, an evacuation request pertaining to a set of memory pages (which may be one page or multiple pages of memory) is received. For example, the evacuation request may represent an atomic evacuation operation on physical memory that supports a higher level operation requested of the virtual memory subsystem (e.g., load balancing, evacuating a large number of memory blocks, etc.). The set of memory pages may include one or more pages of physical memory. With reference to the example of FIG. 2, the aforementioned set of memory pages is represented by page 242, i.e., the source page(s) associated with the copypage( ) operation 204.

In step 304, new DMA operations involving a range of physical memory that includes at least the set of memory pages associated with the evacuation request are inhibited. As mentioned, the inhibiting mechanism may involve including the availability status of the set of memory pages as part of the availability status of DMA resources required to service the DMA request. Memory pages associated with a pending evacuation request are deemed “unavailable” until the pending evacuation request is completed.

In an embodiment, the I/O subsystem is responsible for determining whether DMA resources are available to service a given DMA request. By having the virtual memory subsystem inform the I/O subsystem of the existence of a pending evacuation request, along with the memory pages affected, the I/O subsystem may deem DMA resources (which now includes the availability status of a range of memory) available or unavailable for new DMA requests. Note that DMA requests involving DMA operations that do not involve the memory pages that are DMA-inhibited may continue to occur substantially unaffected.

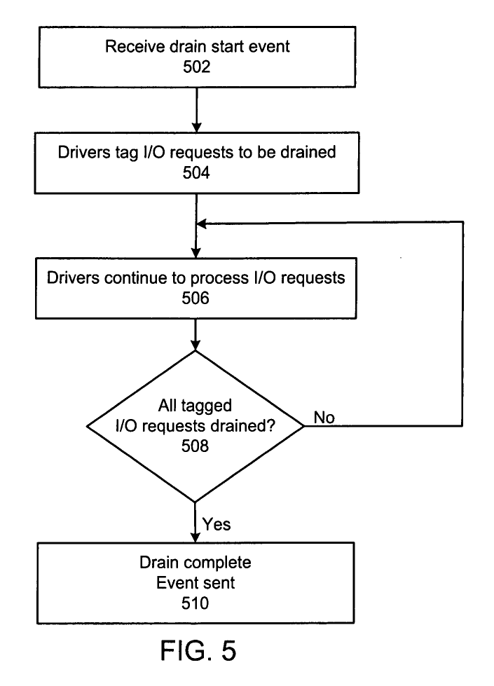

In step 306, existing DMA requests that pertain to the set of memory pages involved in the evacuation request are drained. As mentioned, with reference to the example of FIG. 2, the aforementioned set of memory pages is represented by page 242, i.e., the source page(s) associated with the copypage( ) operation 204. The draining in step 306 ensures that once the evacuation operation pursuant to the evacuation request takes place, DMA operations pursuant to existing DMA requests on the set of memory pages involved in the evacuation request will not occur. FIG. 5 herein further illustrates an implementation of DMA requests draining.

In step 308, the evacuation operation is allowed to take place after the existing DMA requests are drained. In an embodiment, once the evacuation operation is complete, the set of memory pages associated with the now-completed evacuation operation is deemed available by the I/O subsystem (with notification from the virtual memory subsystem), which in turn causes the I/O subsystem to deem the DMA resources available for any pending DMA requests that involve the same set of memory pages. Accordingly, DMA requests pertaining to the same set of memory pages may proceed (step 310).

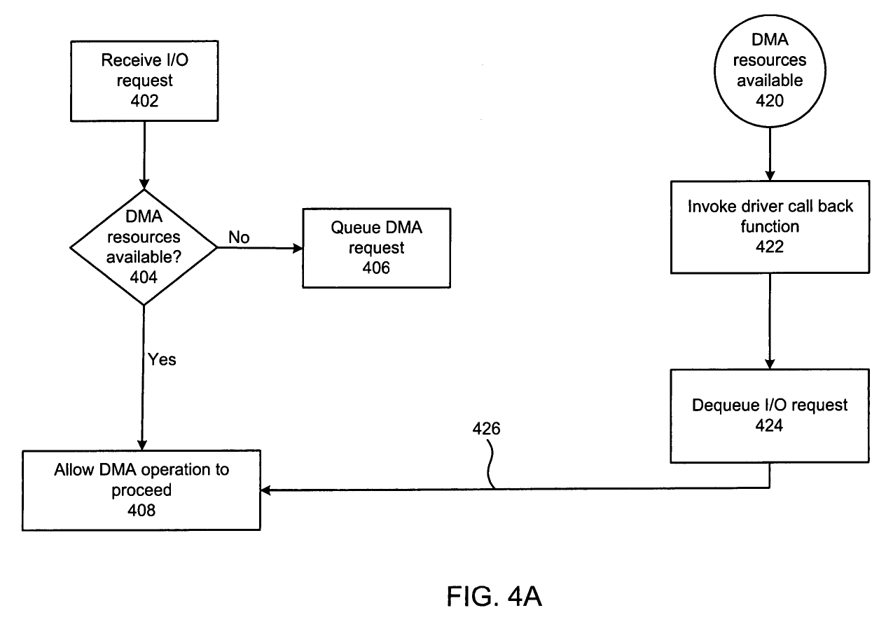

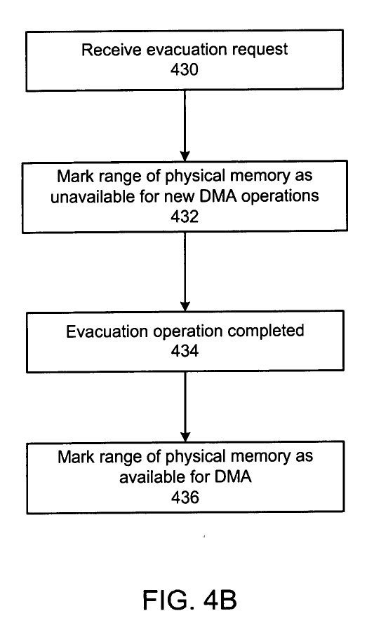

FIGS. 4A and 4B show, in accordance with an embodiment of the present invention, an implementation of the DMA/evacuation synchronization. In step 402 of FIG. 4A, an I/O request is received at an entry point in an I/O driver, causing the driver to make a DMA request to the I/O subsystem. In step 404, it is ascertained whether DMA resources are available for this DMA request. As mentioned, the DMA resources include the availability status for a particular range of physical memory. If that range of physical memory is involved with a pending evacuation request, such range of physical memory (as well as the DMA resources associated therewith) is deemed unavailable.

If the DMA resources are unavailable (as determined in step 404), the driver places the DMA request into an I/O queue to wait until such time that the DMA resources become available (step 406).

On the other hand, if the DMA resources are available (as determined in step 404), the DMA operation associated therewith is allowed to occur (step 408).

Suppose the DMA resources are unavailable and the DMA request becomes a deferred DMA request and pending in the I/O queue in accordance with step 406. At some point in time, the evacuation operation is completed, and the I/O subsystem determines that the DMA resources are now available (step 420). In step 422, the kernel employs the driver callback function to invoke the driver associated with the deferred DMA request, causing the DMA request to be de-queued from the I/O queue for execution (step 424). Thereafter, the DMA operation associated with previously deferred I/O request is permitted to occur (arrow 426 to step 408).

FIG. 4B shows, in accordance with an embodiment of the invention, the steps taken responsive to receiving an evacuation request. In step 430, the evacuation request pertaining to a block of memory is received. In step 432, a range of physical memory that includes at least the memory pages associated with the evacuation request is marked as unavailable for new DMA operations. For example, the virtual memory subsystem may inform the I/O subsystem that a particular range of physical memory is associated with an evacuation request, and the I/O subsystem may inhibit any new DMA request that involves that range of physical memory until the pending evacuation request is completed.

In step 434, a notification of the completion of the evacuation operation is received. In step 436, the range of memory associated with the formerly pending evacuation request is now deemed available for DMA operation, which may cause the DMA resources to be deemed available to a pending DMA request if other aspects of the DMA resources are also available.

FIG. 5 illustrates, in accordance with an embodiment of the present invention, the steps for draining existing DMA requests that involve a range of memory associated with an evacuation request. In step 502, a drain start event is received. The drain start event may be triggered by the receipt of an evacuation request, for example. In step 504, drivers executing on the computer system tag I/O requests whose range of memory overlaps the range of memory associated with the evacuation request and track these I/O requests as I/O requests that need draining. In an embodiment, all drivers are informed of the range of memory of the evacuation request, and drivers that are servicing I/O requests whose range of memory overlaps the range of memory of the evacuation request track these I/O requests as I/O requests that need draining before the evacuation operation pursuant to the evacuation request can be serviced. In an embodiment, these I/O requests are tracked in a central register and when all are drained, the evacuation operation is permitted to begin.

While the I/O requests whose range of memory overlaps the range of memory of the evacuation request are waiting to be drained, other I/O requests may continue as normal (step 506). In step 508, it is ascertained whether all I/O requests whose range of memory overlaps the range of memory associated with the evacuation request have been drained. If they all have been drained, the evacuation operation may begin. In an embodiment, a drain complete event is generated and sent to the virtual memory subsystem to enable the evacuation operation to begin.

As can be appreciated from the foregoing, embodiments of the invention enable DMA operations and evacuations to be synchronized with respect to a block of physical memory in a manner that causes little impact to system performance. Since DMA operations are inhibited only with respect to a limited range of physical memory and only until the evacuation operation is completed, the impact on system performance is limited. Furthermore, since the mechanism involved with synchronizing in accordance with embodiments of the present invention employ existing I/O, virtual memory, and driver OS architectures with only minor modifications, the synchronization capability may be provided without requiring complex I/O hardware specific solutions or substantial changes to the current hardware and/or software of existing computer systems.

While this invention has been described in terms of several embodiments, there are alterations, permutations, and equivalents, which fall within the scope of this invention. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. In a computer system, a computer-implemented method for performing an evacuation request pertaining to a set of memory pages, comprising:
inhibiting new DMA operations on a range of memory, said range of memory overlaps with at least a first portion of said set of memory pages associated with said evacuation request;
deferring evacuating said set of memory pages pursuant to said evacuation request until all existing DMA requests that pertain to at least a second portion of said set memory pages are drained;
performing said evacuating after said draining is completed for said all existing DMA requests; and
enabling said new DMA operations after said performing said evacuating is completed.

2. The method of claim 1 wherein said inhibiting includes queuing new DMA requests pertaining to said new DMA operations while said evacuating is deferred.

3. The method of claim 2 wherein said inhibiting further comprising sending data pertaining to said set of memory pages from a virtual memory subsystem to an I/O subsystem of an operating system kernel executing in said computer system.

4. The method of claim 1 wherein said draining includes:
continuing to service incoming DMA requests, except requests pertaining to said new DMA operations on said range of memory, while said existing DMA requests are drained.

5. The method of claim 1 wherein said range of memory represents a minimum amount of memory that can be inhibited and that also includes said at least a third portion of said set of memory pages associated with said evacuation request.

6. The method of claim 1 wherein DMA operations pertaining to memory outside of said range of memory are permitted to proceed substantially unaffected in view of said evacuation request, said inhibiting, and said draining.

7. The method of claim 1 wherein said range of memory represents memory in a hard partition within said computer system.

8. The method of claim 1 wherein said set of memory pages represents a set of source pages associated with said memory evacuation request.

9. The method of claim 1 wherein said set of source pages represent a single memory page.

10. In a computer system, a computer-implemented method for synchronizing memory evacuation requests and direct memory access (DMA) requests with respect to a block of physical memory, comprising:
receiving an evacuation request for evacuating a set of memory pages, said set of memory pages including at least a page of memory in said block of physical memory;
inhibiting new DMA operations on a range of physical memory, said range of physical memory overlaps with at least a portion of said set of memory pages associated with said evacuation request;
draining existing DMA requests that pertain to said set memory pages;
performing said evacuating after said draining is completed; and
enabling said new DMA operations after said performing said evacuating is completed.

11. The method of claim 10 wherein said inhibiting includes sending data pertaining to said set of memory pages from a virtual memory subsystem to an I/O subsystem of an operating system kernel executing in said computer system.

12. The method of claim 10 wherein said draining includes:
continuing to service incoming DMA requests, except requests pertaining to said new DMA operations on said range of physical memory, while said existing DMA requests are drained.

13. The method of claim 12 further comprising:
tracking said draining of said existing DMA requests to ascertain when said draining is completed for all of said existing DMA requests; and
enabling said performing after said draining of said all of said existing DMA requests is completed.

14. The method of claim 10 wherein said range of memory represents a minimum amount of memory that can be inhibited and that also includes said at least a portion of said set of memory pages associated with said evacuation request.

15. The method of claim 10 wherein said requests pertaining to said new DMA operations on said range of memory are queued if said requests are received prior to said enabling said new DMA operations.

16. The method of claim 10 wherein DMA operations pertaining to memory outside of said range of memory are permitted to proceed substantially unaffected in view of said evacuation request, said inhibiting, and said draining.

17. The method of claim 10 wherein said range of memory represents memory in a hard partition within said computer system.

18. The method of claim 10 wherein said enabling includes performing driver call backs with respect to drivers that have sent requests pertaining to said new DMA operations.

19. The method of claim 10 wherein said range of physical memory represents at least part of DMA resources that are tracked by an I/O subsystem of an operating kernel executed in said computer system, said DMA resources being deemed unavailable to said new DMA operations if said evacuating is not completed.

20. The method of claim 10 wherein said set of memory pages represents a set of source pages associated with said memory evacuation request.

21. The method of claim 10 wherein said set of source pages represent a single memory page.

22. An article of manufacture comprising a program storage medium having computer readable code embodied therein, said computer readable code being configured to perform an evacuation request pertaining to a set of memory pages, comprising:
computer readable code for inhibiting new DMA operations on a range of memory, said range of memory overlaps with at least a first portion of said set of memory pages associated with said evacuation request;
computer readable code for deferring evacuating said set of memory pages pursuant to said evacuation request until all existing DMA requests that pertain to at least a second portion of said set memory pages are drained;
computer readable code for performing said evacuating after said draining is completed for said all existing DMA requests; and
computer readable code for enabling said new DMA operations after said performing said evacuating is completed.

23. The article of manufacture of claim 22 wherein said computer readable code for inhibiting includes computer readable code for queuing new DMA requests pertaining to said new DMA operations while said evacuating is deferred.

24. The article of manufacture of claim 23 wherein said computer readable code for inhibiting further comprising computer readable code for sending data pertaining to said set of memory pages from a virtual memory subsystem to an I/O subsystem of an operating system kernel executing in said computer system.

25. The article of manufacture of claim 22 wherein DMA operations pertaining to memory outside of said range of memory are permitted to proceed substantially unaffected in view of said evacuation request, said inhibiting, and said draining.

26. The article of manufacture of claim 22 wherein said range of memory represents memory in a hard partition within said computer system.

27. The article of manufacture of claim 22 wherein said set of memory pages represents a set of source pages associated with said memory evacuation request.
